(19) United States
(12) Patent Application Publication
(10) Pub. No.: US 2001/0037878 A1
(43) Pub. Date: Nov. 8, 2001

(54) Header-less vehicle radiator

(76) Inventors: Viktor Brost, Aichtal (DE); Bernhard Lamich, Esslingen (DE)

Correspondence Address: WOOD, PHILLIPS, VanSANTEN,, CLARK & MORTIMER, Suite 3800, 500 West Madison Street, Chicago, IL, 60661, US

(21) Appl. No.: 09/837,072

(22) Filed: Apr. 18, 2001

(30) Foreign Application Priority Data
Apr. 10, 2000 (DE) 100 19 268.8
Dec. 2, 2000 (DE) 100 60 006.9

(51) Int. Cl. F28F 9/02; B23P 15/26; B21D 39/06; B21D 53/02; B21D 53/04; B21D 53/06; B21D 53/08

(52) U.S. Cl. 165/175; 29/890.043

(57) ABSTRACT

A “header-less” radiator utilizes a radiator core including tubes having end walls which are bifurcated for a short distance from the ends of the tubes and having one or both of the side walls in the bifurcated segment of the tube formed outward and adapted to contact and be joined in a fluid tight manner with the side wall of an adjacent tube in the radiator core. A collecting tank has walls extending partially over the core to a distance beyond the bifurcation of the side walls, and joined to the end walls of the tubes in a fluid tight manner, such that the walls of the collecting tank in conjunction with the bifurcated end walls and outwardly formed side walls of the tubes define a common fluid plenum providing fluid communication between the tubes and the collecting tank. In various disclosed forms, the bifurcation terminates in a smooth curve, or a second bifurcation is provided to facilitate manufacture and enhance performance.

This patent application claims priority under 35 USC § 119 to commonly assigned German patent applications DE 100 19 268.8, filed Apr. 19, 2000, and DE 100 60 006.9, filed on Dec. 2, 2000.

### FIELD OF THE INVENTION

This invention relates to heat exchangers, and more particularly to radiators of the type used in vehicles.

### BACKGROUND

Many types of engine powered vehicles utilize a heat exchanger, commonly known as a radiator, to dissipate heat from engine coolant to the ambient air. Such radiators often include a radiator core having a plurality of tubes, through which the coolant flows. The tubes are spaced apart from one another by fins which conduct heat away from the tubes, and dissipate the heat to ambient air which is drawn or forced through the fins between the tubes. To facilitate heat transfer and construction of the radiator, the tubes typically have an elongated rectangular cross-section, with long side walls extending through the radiator core for contacting the fins, and short end walls joining the two side walls of the tubes.

In one venerable construction of such a radiator, the ends of the tubes are fitted into holes in a header plate, and the joint between the outside surface of the tubes and the header plate is sealed by soldering, brazing, welding or adhesive bonding the outer surface of the tubes to the header plate. A collecting tank is then joined to the header plate in such a manner that the header plate and tank in combination form a fluid tight reservoir or plenum connecting the open ends of the tubes to a common source of coolant fluid. This construction is undesirable because the header plate, and the operation of joining the tubes to the header plate, involve parts and process steps that add cost and reduce reliability. This construction is also undesirable because fluid flowing between the tubes and the reservoir or plenum must make abrupt turns and may undergo rapid expansion or contraction.

In another prior radiator construction, the header plate is combined into the collecting tank through the use of a tubular structure for the collecting tank. The ends of the tubes are contoured and formed to fit into slots in the tubular tank structure. The outer surfaces of the tubes are then joined in a fluid tight manner to the tubular tank structure to form a common reservoir or plenum connecting the tubes. While this construction provides improved manufacturability, by combining the header and tank into one part, the transition for fluid flowing between the plenum and the tubes is still more abrupt and torturous than is desirable.

To facilitate fluid flow, the ends of the tubes joining the tubular tank structure have, in some instances, been enlarged by stretching the walls of the tube at the end joining the tubular tank structure. This typically requires that the tubes have walls that are undesirably thick, however, so that the walls of the tube at the enlarged end will still have sufficient thickness and strength for reliable service after the wall of the tube is thinned by stretching. The additional wall thickness is undesirable because it inhibits heat transfer, adds weight and cost, and necessitates the use of relatively large corner radii in fabricating the tubes, to avoid cracking of the tube walls during formation of the tubes. The increased corner radii result in larger gaps to be filled during the process of joining the tubes to the tubular tank structure to form a fluid tight construction, thereby making fabrication more difficult and introducing potential points of failure in operation. An example of this construction is disclosed in German Offenlegungsschrift DE 3834822 A1.

In another construction, the header plates are eliminated by stretching the end walls of the tubes for a short distance adjacent the ends of the tubes to such a degree that the ends of the side walls of adjacent tubes extend across the spaces occupied by the fins and into contact with one another. The side wall ends of the adjacent tubes are then joined to one another, to essentially replace the header plates in the first construction described above, and a tank structure is joined to the stretched end walls of the tubes in a fluid tight manner to form the common reservoir or plenum. Such a construction provides advantages by eliminating the need for a separate header plate, and by providing a smoother transition for fluid flowing between the tubes and the common plenum, but still suffers from the disadvantages of requiring a thicker tube wall as described above. Examples of this construction are disclosed in German patent application number 195 43 986 A1; German Utility Model No. 1 519 204; and German DE-PS 1 551 448.

An improved radiator and method of constructing such an improved radiator that is of essentially “header-less” construction and avoids the problems described above is disclosed in a co-pending United States patent application bearing attorney docket number 655.00948, which is incorporated herein by reference. The radiator disclosed in United States patent application bearing attorney docket number 655.00948 utilizes a radiator core including tubes having end walls which are bifurcated for a short distance from the end of the tube and having one or both of the side walls in the bifurcated segment of the tube formed outward and adapted to contact and be joined in a fluid tight manner with the side wall of an adjacent tube in the radiator core. A collecting tank has walls extending over the core to a distance beyond the bifurcation of the side walls, and joined to the end walls of the tubes in a fluid tight manner, such that the walls of the collecting tank in conjunction with the bifurcated end walls and outwardly formed side walls of the tubes define a common fluid plenum providing fluid communication between the tubes and the collecting tank.

The radiator disclosed in United States patent application bearing attorney docket number 655.00948 thus eliminates the need for a separate header plate and provides an improved transition for fluid flowing between the collecting tank and the tubes without the need for stretching the end walls of the tubes. The walls of the collecting tank perform the function provided by the stretched end walls of prior radiator structures. The tubes can thus have thinner walls for improved heat transfer and reduced cost and weight. Tighter bend radii can be used in forming the tubes, without fear of introducing cracks in the corners of the tubes, thereby facilitating manufacture of the radiator by reducing the size of gaps between the tubes and adjoining structures in prior radiator constructions. A direct reduction in weight and material cost is also provided by virtue of this construction, because the redundant function provided by the combined thickness of the stretched tube end walls and the walls of the collecting tank or other structure attached to the stretched end walls is eliminated.

In some of the structures and methods disclosed in our United States patent application bearing attorney docket number 655.00948, only one side wall of each tube will be formed to contact the side wall of an adjacent tube. In other embodiments, both side walls will be formed. Our disclosed improved radiator contemplates alternate methods of forming the side walls of the tubes. The side walls can be formed during fabrication of the tubes, after the tubes are fabricated but not yet assembled into the radiator core, or after the tubes are assembled into the core.

Although the structures and methods disclosed in the United States patent application bearing attorney docket number 655.00948 solve the problems discussed above for many radiator configurations, certain applications present additional problems to be dealt with in fabricating a radiator. The structures and methods disclosed in our previously filed United States patent application can generally be practiced with commonly utilized tube materials and configurations. There are, however, some tube materials, tube shapes, and/or extreme operational environments in which it is desirable to modify the structures and methods disclosed in our previous patent application, to include additional features for improving resistance to the formation of cracks in the tube end walls during the process of adapting the bifurcated ends of the tubes to contact adjacent tubes, and to reduce the possibility that a stress crack might initiate at the point of bifurcation as a result of operation of the radiator for extended periods in high vibration environments. This is particularly true where the tubes are configured with wide end walls that must be bent as part of the process of adapting the tube ends to contact an adjacent tube.

Tubes having very thin side walls may also be difficult to keep in intimate contact with one another during fabrication of the core. Some means and method of providing “self fixturing” would be beneficial in addressing this problem.

Also, the side walls of tubes in radiators often include one or more longitudinally extending internal or external ribs, or a pattern of dimples to increase stiffness or to improve heat transfer. These ribs or dimples can make it more difficult to obtain a fluid tight seal between the adapted side wall of a tube and an adjacent tube.

### SUMMARY

Our invention provides an improved radiator addressing the problems defined above through the use of a radiator core including tubes having bifurcated end walls configured in a formed region of the tube to provide resistance to cracking at the point of bifurcation, and/or to provide a flat joining surface for tubes having ribs or dimples, to facilitate formation of fluid tight joints between adjacent tubes and between the tubes and a collecting tank.

In one form of our invention, a radiator includes a radiator core having tubes including a bifurcated segment with end walls which terminate at a distance from the end of the tube in a smooth curve and having one or both of the side walls in the bifurcated segment of the tube formed outward and adapted to contact and be joined in a fluid tight manner with the side wall of an adjacent tube in the radiator core. A collecting tank has walls extending over the core to a distance beyond the bifurcation of the side walls, and joined to the end walls of the tubes in a fluid tight manner, such that the walls of the collecting tank in conjunction with the bifurcated end walls and outwardly formed side walls of the tubes define a common fluid plenum providing fluid communication between the tubes and the collecting tank.

Our invention thus eliminates the need for a separate header plate and provides an improved transition for fluid flowing between the collecting tank and the tubes without the need for stretching the end walls of the tubes. In our radiator, the walls of the collecting tank perform the function provided by the stretched end walls of prior radiator structures. The tubes in our radiators can thus have thinner walls for improved heat transfer and reduced cost and weight. We can utilize tighter bend radii without fear of introducing cracks in the corners of the tubes, and facilitate manufacture of the radiator by reducing the size of gaps between the tubes and adjoining structures in prior radiator constructions. By terminating the bifurcation in a smooth curve, there is no sharp corner to initiate a crack in the bifurcated end wall during fabrication of the tube or operation of the radiator.

In some embodiments of our invention, only one side wall of each tube will be formed to contact the side wall of an adjacent tube. In other embodiments, both side walls will be formed. Our invention contemplates alternate methods of forming the side walls of the tubes. The side walls can be formed during fabrication of the tube, after the tubes are fabricated but not yet assembled into the radiator core, or after the tubes are assembled into the core, as may be required or preferred by those constructing a radiator according to our invention.

In some forms of our invention, the bifurcation is formed by a slot opening at one end of the tube, and having sides spaced by the width of the slot joined at a distance from the end of the tube by a smooth curve forming a rounded end of the bifurcation. In other forms of our invention, the end walls include a slit of negligible width terminated in a circular hole having a diameter larger than the negligible width of the slit.

In radiators utilizing tubes having side walls with longitudinal ribs, our invention facilitates formation of fluid tight joints between adjacent tubes, by compressing the side wall in a constrained manner to form a flattened portion of the side wall. The side wall is compressed in such a manner that material in the rib flows out of the flattened portion, and partially into the end walls of said tube, to thereby provide flat joining surfaces of the flattened side wall and the end walls to facilitate joining of the adapted side wall in a fluid tight manner to the contacted side wall of an adjacent tube, and joining the collecting tank to the end walls in a fluid tight manner.

To facilitate construction in some forms of our invention, the adapted side wall of a tube is attached to the contacted side wall of an adjacent tube by a compression bond, in addition to being joined in a fluid tight manner to the contacted side wall of the adjacent tube.

In some forms of our invention, particularly where the end walls of the tube are wide, the end walls are bifurcated in an asymmetrical manner with respect to the side walls, with a larger portion of the bifurcated end wall joined to a first one of the side walls, and a smaller portion of the bifurcated end wall joined to the second side wall of the tube, and only the second side wall is adapted and joined to the contacted side wall of the adjacent tube.

In other forms of our invention, particularly where the end walls are wide and it is desired to adapt both side walls to contact an adjacent tube, a second bifurcation of the tube is provided. In such forms of our invention, a radiator includes a radiator core defining a front and a rear face thereof and including a plurality of generally rectangular shaped tubes interleaved with layers of fins for passage of air through the core, and a collecting tank attached to the core in a fluid tight manner to provide fluid communication between the tubes and the collecting tank. The tubes have a first and a second side wall extending through the core and joined by end walls at the front and rear face of the core. The tubes terminate at one end thereof in a formed segment wherein the end walls of each tube include a first bifurcation for a first distance from the end of the tube, and a second bifurcation for a second distance from the end of the tube, with a first portion of the end wall joined for the first distance only to the first side wall, a second portion of the end wall joined for the second distance only to the second side wall. A remaining central portion of the end wall is not joined to either the first and second portions of the end wall for the first and second distances respectively. The first and second side walls are adapted to contact a side wall of an adjacent tube in the core, and the adapted side walls are joined in a fluid tight manner to the contacted side wall of the adjacent tube. The collecting tank walls extend over the front and rear faces of the core past the first and second bifurcations of the end walls, and are joined in a fluid tight manner to the end walls of the tubes along and beyond the first and second bifurcations, to thereby form a fluid tight joint between the walls of the collecting tank and the end walls of the tubes.

In some forms of our invention having tubes with both a first and a second bifurcation, at least one of the bifurcations terminates in a smooth curve. In some forms of our invention having both a first and a second bifurcation, the first and second bifurcations extend for the same distance from the end of the tube.

In some forms of our invention, the tubes, the fins, and one or more collecting tanks are assembled in a braze fixture and simultaneously brazed together in a single operation. The steps of adapting the tube ends to include the bifurcations, flattened portions, compression joints, etc., can be performed on the tubes before the core is assembled, or after assembly of the core.

These and other forms, aspects, advantages, and novel features of our invention will be readily apparent upon consideration of the following drawings and detailed description of exemplary and preferred embodiments.

### BRIEF DESCRIPTION OF THE DRAWINGS

FIG. 1 is a partial sectional view of an exemplary embodiment of a radiator according to our invention;

FIGS. 2 and 3 are partial isometrics of the radiator of FIG. 1;

FIGS. 4a-c, and FIG. 4e are partial sections and enlarged detail drawings of the embodiment depicted in FIG. 1;

FIG. 4d is a partial sectional view of an alternate embodiment of a radiator according to our invention having only one side wall of a tube adapted to contact the sidewall of an adjacent tube;

FIGS. 5a-c depict an alternate embodiment of a radiator having an end wall bifurcated by a slot terminating in a smooth curve, and having both side walls adapted to extend over an adjacent layer of fin and into contact with an adapted sidewall of an adjacent tube;

FIGS. 6a-b are an isometric and sectional view respectively of an embodiment of a radiator according to our invention having a longitudinal rib in the tube sidewall that is compressed in a flattened area of the sidewall to facilitate joining the side walls of adjacent tubes;

FIGS. 7 is an isometric depicting joining adjacent tubes with a compression bond in addition to a fluid tight joint;

FIGS. 8a-c depict an embodiment of our invention in which the tube end walls are bifurcated in an asymmetric manner, and only one sidewall is adapted to contact the sidewall of an adjacent tube; and

FIGS. 9a-e depict an alternate embodiment of a radiator according to our invention, in which the ends of the tubes include a first and second bifurcation.

### DETAILED DESCRIPTION

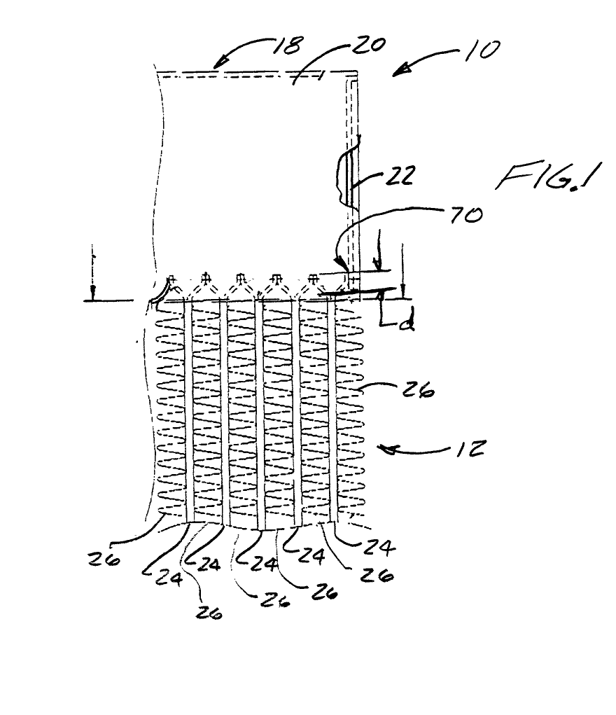

FIG. 1 depicts an exemplary embodiment of our invention in the form of a radiator 10 for a vehicle. The radiator 10 includes a radiator core 12, and a pair of collecting tanks 18 (only one is shown) each having a generally U-shaped body 20 and end plates 22.

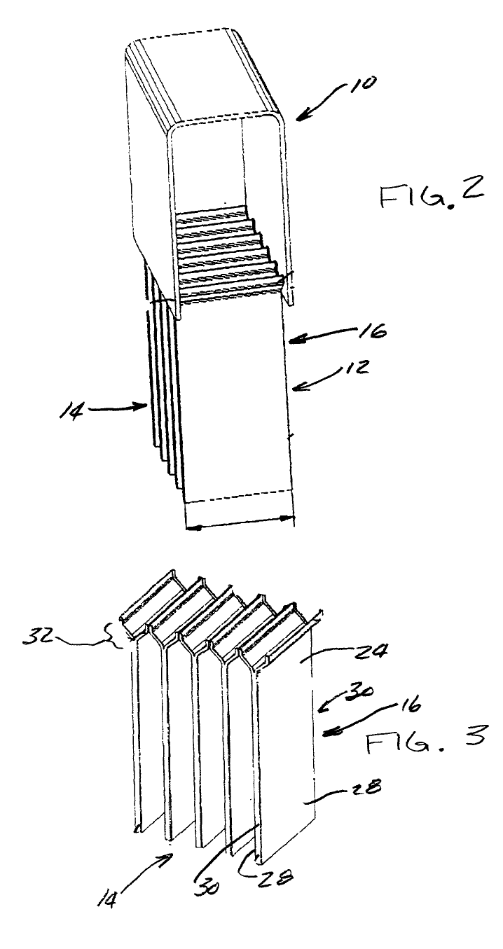

The radiator core 12 defines a front face 14 and rear face 16 thereof, as shown in FIGS. 1 and 2, and includes a plurality of tubes 24 interleaved with layers of serpentine fins 26 which allow passage of air through the core 12.

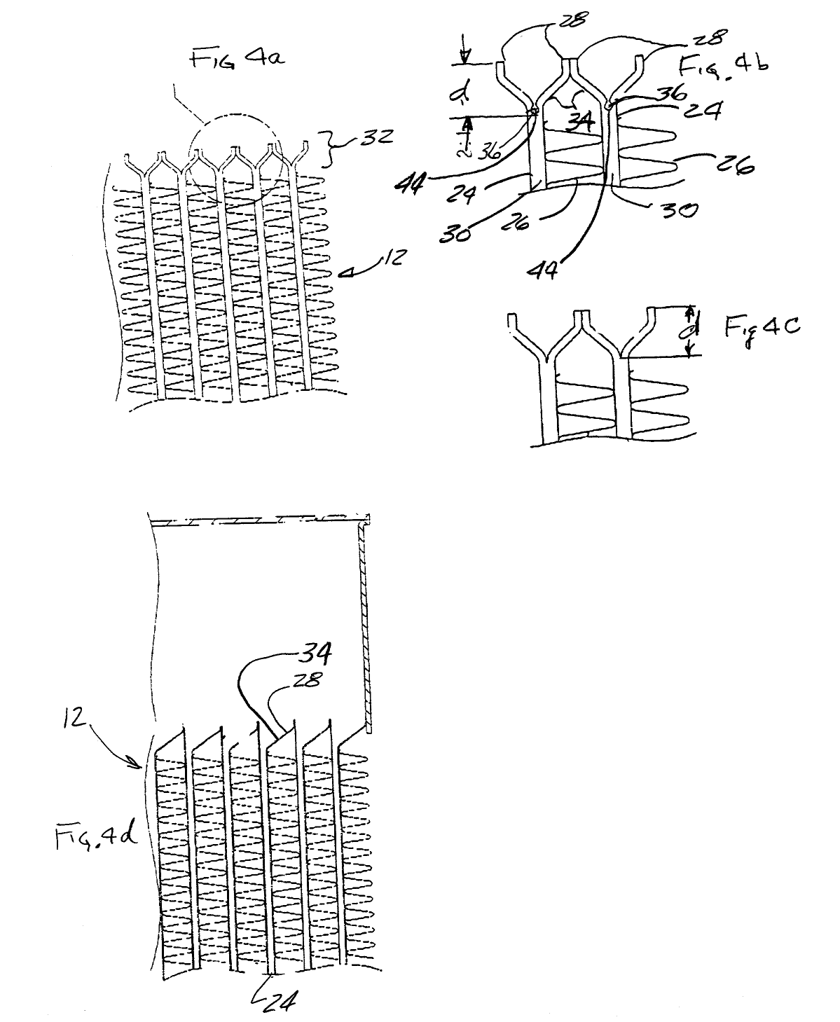

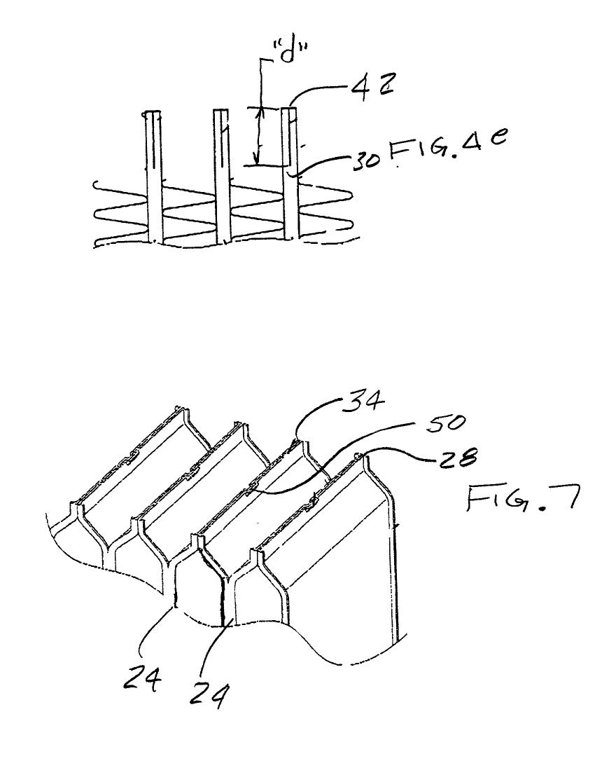

As will be understood by examining FIGS. 1-3, and FIG. 4a-c, the tubes 24 have a generally rectangular cross-section formed by a pair of side walls 28 extending through the core 12 joined by a pair of end walls 30, one end wall 30 of the pair being positioned at the front face 14 of the core, and the other at the rear face 16 of the core 12. The tubes 24 terminate at one or both ends thereof in a formed segment 32 in which the end walls 30 are bifurcated for a distance “d” from the end of the tube 24, and one or both of the side walls 28 is adapted to extend over an end of the fin 26 and contact a side wall 28 of an adjacent tube 24 in the core 12. FIGS. 1-4c depict a form of our invention in which both side walls 28 in the formed segment 32 of each tube 24 are adapted by forming them outward in wing-like fashion to provide an adapted side wall 34 extending halfway across an adjacent layer of fins 26, and into contact with the wing-like adapted side wall 34 of the formed segment 32 of an adjacent tube 24 when the tubes 24 are assembled into the core 12. FIG. 4d depicts a form of our invention in which only one of the side walls 28 in the formed segment 32 of each of the tubes 24 in the radiator core 12 is adapted by forming it outward in a wing-like fashion to provide an adapted side wall 34 extending completely across an adjacent end of the fin 26, and into contact with the straight side wall 28 of an adjacent tube 24.

The tubes 24 and fins 26 are joined together, and the adapted side walls 34 in the formed segments 32 of the tubes are joined in a fluid tight manner to the contacted side wall 28 of the adjacent tube 24. As used herein, the term “joined in a fluid tight manner” includes but is not limited to joining by welding, brazing, soldering, swaging, and adhesive bonding.

As shown in FIG. 1, the legs of the U-shaped body 20 of the collecting tank 18 extend over the front and rear faces 14, 16 of the radiator core 12, for a distance longer than the distance “d” of bifurcation of the end walls 30 and are joined in a fluid tight manner to the end walls 30 of the tubes 24 throughout and beyond the bifurcation distance “d.” The end plates 22 of the collecting tank 18 are joined in a fluid tight manner to the U-shaped body 20 of the collecting tank 18, and to a side wall 28 of the end tube 24 in the core 12, to form a common plenum providing fluid communication between the tubes 24 and the collecting tank 18.

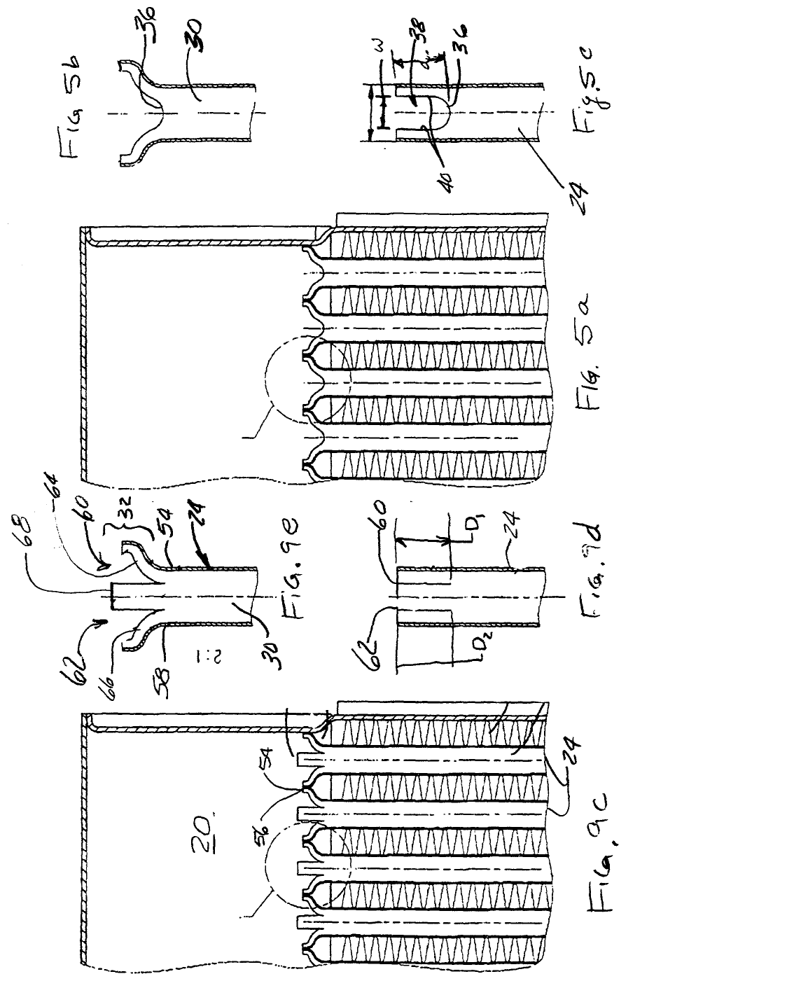

As shown in FIGS. 4b, and 5a-c, at least some of the bifurcations are terminated in a smooth curve 36, rather than in a sharp corner as depicted in FIG. 4c. As used herein, the term “smooth curve” is defined as a non-straight line that is continuous in a geometric sense.

In the form depicted in FIGS. 5a-c, the bifurcation is formed by a slot 38 opening at one end of a tube 24, and having sides 40 spaced by a slot width “w” joined at a distance “d” by a smooth curve 36 to form a rounded end of the bifurcation. In other forms of our invention, as shown in FIGS. 4b and 4e, the end walls of a tube 24 include a slit 42 of negligible width, and the slit 42 terminates at a distance “d” from the end of the tube 24 in a circular hole having a diameter larger than the negligible width of the slit 42. By using a smooth curve or circular hole to terminate the bifurcation, the possibility of initiating a crack at the end of the bifurcation during fabrication of the radiator or under operating conditions is lessened.

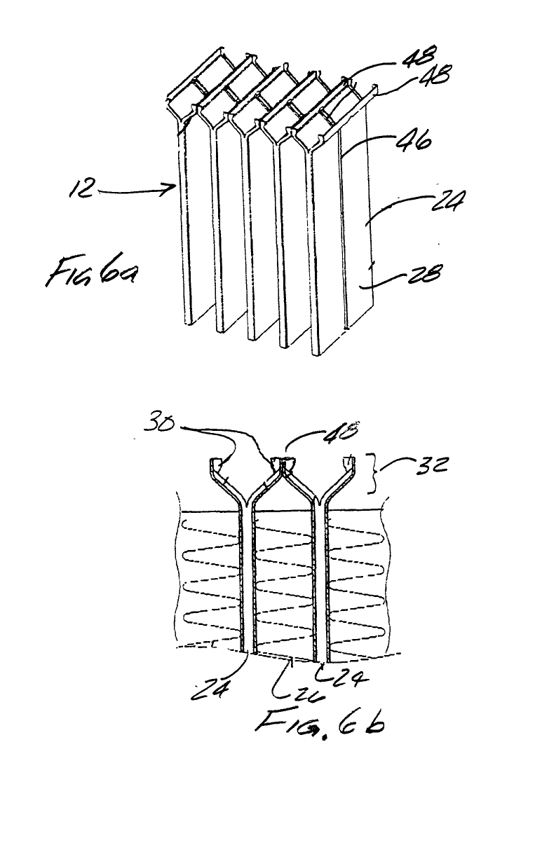

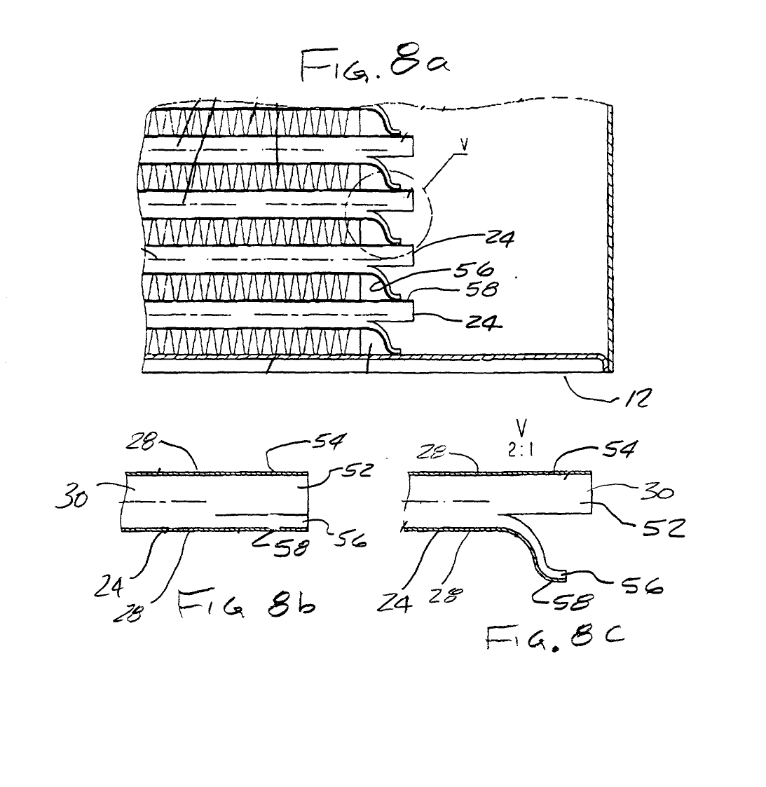

In the embodiment depicted in FIGS. 6a-b, the side walls 28 of the tubes 24 include a longitudinal rib 46 extending into the interior of the tubes 24. When the tubes 24 and layers of fin 26 are stacked together to form the core 12, these ribs 46 would form a gap which would make it more difficult to obtain a fluid tight joint between adjacent tubes 24. As shown in FIGS. 6a-b, however, the longitudinal rib is removed from a flattened portion 48 of the adapted side walls 32 by compressing the flattened portion 48 in a constrained manner such that tube side wall material in the rib 46 flows out of the flattened portion and partially into the end walls 30, so that when the tubes 24 and fins 26 are stacked to form the core 12, the flattened portion 48 of the adapted side wall 28 will more intimately abut the contacted side wall 28 of an adjacent tube 24.

FIG. 7 depicts an embodiment in which the adapted side walls 34 of the tubes are attached to the contacted side walls 28 of adjacent tubes 24 by a compression bond 50 in addition to being joined in a fluid tight manner. As used herein, the term “compression bond” is contemplated to include a mechanical or a metallurgical bond formed by such processes known in the industry as: crimping; staking; spot welding, brazing, or soldering; or adhesive spot bonding. The compression bond 50 functions primarily as an aid in fabrication of the core 12 by holding the side walls 28 of adjacent tubes together during formation of the fluid tight joint, but also adds to the structural integrity of the core 12.

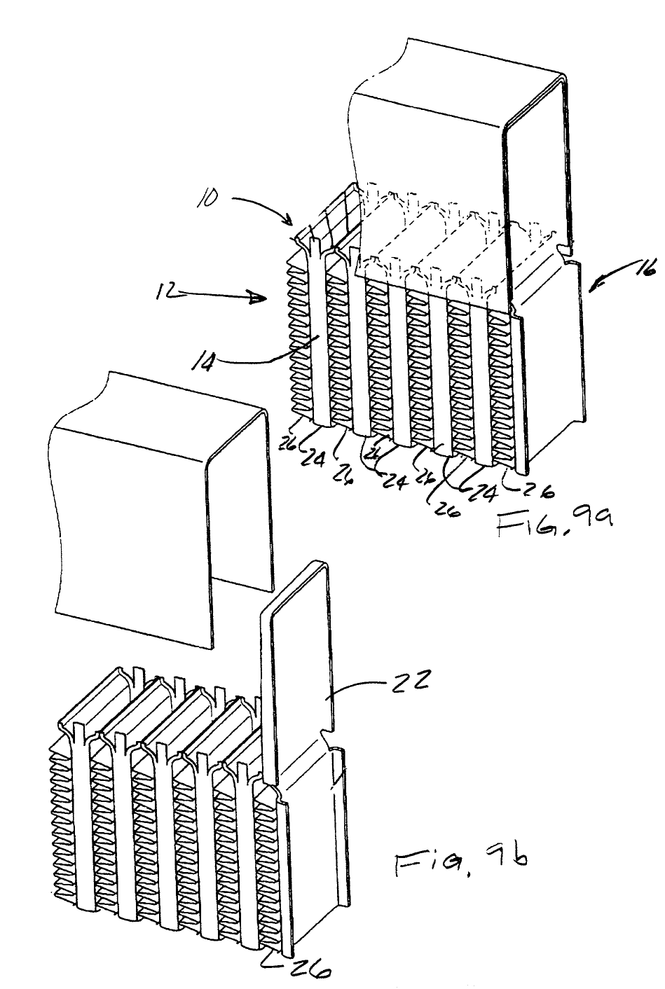

FIGS. 8a-c depict a form of our invention in which the end walls 30 of the tubes 24 are bifurcated in an asymmetrical manner with respect to the side walls 28, with a larger portion 52 of the bifurcated end wall 30 remaining joined to a first one of the side walls 28, and a smaller portion 56 of the bifurcated end wall 30 remaining joined to the second side wall 58 of the tube 24. Only the second side 58 of the tube 24 is adapted and joined to the contacted first side wall 54 of an adjacent tube 24, as shown in FIG. 8a. This configuration is of particular advantage where the end walls 30 of the tubes 24 are relatively wide, and would require considerable stretching of the bifurcated end wall 30 if the tubes 24 were bifurcated along the centerline of the tubes 24.

FIGS. 9a-e show a form of our invention in which the end walls 30 of the tubes 24 are wide and it is desired to adapt both side walls 28 to contact an adjacent tube 24. In this form of our invention a first and a second bifurcation 60, 62 of the tubes 24 are provided. In such forms of our invention, a radiator 10 includes a radiator core 12 defining a front and a rear face 14, 16 thereof and including a plurality of generally rectangular shaped tubes 24 interleaved with layers of fins 26 for passage of air through the core 12, and a collecting tank 18 attached to the core 12 in a fluid tight manner to provide fluid communication between the tubes 24 and the collecting tank 18. The tubes 24 have a first and a second side wall 54, 58 extending through the core 12 and joined by end walls 30 at the front and rear face 14, 16 of the core 12. The tubes 24 terminate at one end thereof in a formed segment 32 wherein the end walls 30 of each tube 24 include a first bifurcation 60 for a first distance “D₁” from the end of the tube 24, and a second bifurcation 62 for a second distance “D₂” from the end of the tube 24, with a first portion 64 of the end wall 30 joined for the first distance “D,” only to the first side wall 54, a second portion 66 of the end wall 30 joined for the second distance “D₂” only to the second side wall 58. A remaining central portion 68 of the end wall 30 is not joined to either the first or second portions 64, 66 of the end wall 30 for the first and second distances “D₁,D₂” respectively. The first and second side walls 54, 58 are adapted to contact a side wall of an adjacent tube 24 in the core 12, and the adapted side walls are joined in a fluid tight manner to the contacted side wall of the adjacent tube 24. The walls of the U-shaped body 20 of the collecting tank 18 extend over the front and rear faces 14, 16 of the core 12 past the first and second bifurcations 60, 62 of the end walls 30, and are joined in a fluid tight manner to the end walls 30 of the tubes 24 along and beyond the first and second bifurcations 60, 62, to thereby form a fluid tight joint between the walls 22 of the collecting tank and the end walls 30 of the tubes.

In some forms of our invention having tubes 24 with both a first and a second bifurcation 60, 62, at least one of the bifurcations terminates in a smooth curve in the same manner as described above in relation to forms of the invention having only a single bifurcation of the end walls 30 of the tubes 24. In some forms of our invention having both a first and a second bifurcation 60, 62, the first and second bifurcations extend for the same distance from the end of the tube, i.e. “D₁” and “D₂” are substantially equal.

The bifurcated end wall 30 in the formed segment 32 of the tube 24 allows adaptation of the end of the tube 24, as described above, without locally stretching (expanding) and thinning the end wall as is required in prior radiator designs.

In one exemplary form of our invention a header-less radiator 10 as described above is manufactured by a method including the steps of:

fabricating a plurality of tubes 24, each having a generally rectangular cross section comprised of a pair of spaced side walls 28 joined by a pair of end walls 30;

adapting one end of each of the tubes 24 to provide a formed segment 32 having end walls 30 that are bifurcated for a distance “d” from one end of the tubes 30, and at least one adapted side wall 34 in the formed segment 32 adapted to contact and seal against a side wall 28 of an adjacent tube 24 when the tubes 24 are joined together in an interleaved configuration with layers of fin 26 to form a radiator core 12, the bifurcation terminating in a smooth curve 36 at the distance “d” from the one end;

assembling a radiator core 12 in a manner defining a front and a rear face 14, 16 thereof and including the plurality of the generally rectangular shaped tubes 24 interleaved with layers of fins 26 for passage of air through the core 12; with the side walls 28 of the tubes 24 extending through the core 12, and the end walls 30 positioned at the front and rear faces 14, 16 of the core 12; and with the adapted side walls 34 in the formed segments 32 of the tubes 24 contacting a sidewall 28 of an adjacent tube 24 in the core 30;

joining each adapted side wall 34 in the formed segments 32 in a fluid tight manner to the contacted side wall 28 of an adjacent tube 24;

attaching a collecting tank 18 with walls thereof extending over the front and rear faces 14, 16 of the core 12, past the bifurcation of the end walls 30 of the tubes 24; and

joining the collecting tank 18 in a fluid tight manner to the end walls 30 of the tubes 24 along and beyond the bifurcation, to thereby form a fluid tight joint between the walls of the collecting tank 18 and the end walls 30 of the tubes 24.

We contemplate that fabrication of the tubes 24 and the step of adapting the end of the tubes 24 can be accomplished by a number of alternative methods, suitable to various materials and manufacturing or operating environments.

For example, the end walls 30 of an extruded seamless tube 24 can be machined to include a slit 42 or a slot 38 extending from the end of the tube 24 a distance “d” to form the bifurcated segment of the end walls 30. The end of the slit 38 can be punched, drilled, or otherwise cut to provide the circular hole 44, and the end of the slot 38 can be punched, drilled, or cut in a manner providing the smooth curve 36. One or both of the side walls 28 in the bifurcated segment can then be bent outward to form an adapted side wall 34. In some instances it may be desirable to complete the step of adapting the ends of the tubes 24 after the core is assembled by forcing a forming tool or fixture into the bifurcated ends of the tubes 24. In other instances, it may also be desirable to perform the step of machining the side walls 30 to form one or more bifurcations and add circular holes 44, or the smooth curve 36 etc., after the core 12 is assembled.

Alternatively, the tubes 24 can be fabricated, as disclosed in our copending patent application bearing attorney docket number 655.00948, by forming a first and a second tube half, each being generally U-shaped with a pair of legs extending in a generally perpendicular direction from one of the side walls. The legs form part of each end wall 30 of the tube 24. The legs of the first and second tube halves are then butted against one another and joined along the abutting surfaces by a fluid tight process, such as welding, or laser welding, to complete formation of the end walls 30 and the tube 24. The two halves may be left un-joined for a distance “d” at the end of the tube to form the bifurcated segment of the end walls 30.

The step of forming the adapted side wall can be performed after the first and second tube halves are joined together, and either prior to, or after assembly of the core as described above. Alternatively the adapted side walls can be formed prior to joining the tube halves together by bending either or both of the first and second tube halves, and incorporating a smooth curve 36, and/or circular hole 44 as may be required into the tube halves.

In some instances it may be desirable to delay joining the tube halves together until after the core 12 is assembled. This can be particularly advantageous when it is desired to join all of the parts of the core 12 or the radiator 10 together in a single process step, for example by constructing the parts of the core 12 or radiator from aluminum coated with a layer of braze material and brazing the entire assembly together simultaneously.

Although we have provided a number of exemplary embodiments in the preceding discussion, those having skill in the art will recognize that our invention may be practiced in many alternate forms within the scope of the appended claims. For example, the end plates 22 of the collecting tank 18 may not extend along the outermost layer of fin 26, as shown in FIG. 9b, but may instead terminate after being joined to the adapted side wall 34 of the outermost tube 24 in the core 12, as indicated at reference numeral 70 of FIG. 1, leaving the outermost layer of fin 26 exposed at the periphery of the radiator 10.

Our invention may also be used with different collecting tank configurations than the forms illustrated in the drawings and description. Our invention may be used in a wide variety of alternate core stacking and flow arrangements, and with straight fins, or many types of fins other than the serpentine fins shown in the drawings.

We also wish to expressly state that, although the exemplary embodiments described above and in the appended claims make detailed reference to the structure and method of forming the tubes and other component parts at one end of a radiator core, we contemplate that in other forms of our invention within the scope of the claims, it may be desirable to utilize a similar structure and/or construction method at more than one end of the tubes, or the radiator core. Finally, our invention may be used in other than radiator applications, i.e., for many different heat exchange operations using fluids other than engine coolant.

It is understood, therefore, that the spirit and scope of the appended claims should not be limited to the specific embodiments described and depicted herein.

We claim:

1. A radiator comprising:
a radiator core defining a front and a rear face thereof and including a plurality of generally rectangular shaped tubes interleaved with layers of fins for passage of air through said core; and
a collecting tank attached to said core in a fluid tight manner to provide fluid communication between said tubes and said collecting tank;
said tubes each having a pair of side walls extending through said core and joined by end walls at said front and rear faces of said core;
said tubes each terminating at one end thereof in a formed segment wherein said end walls of each tube are bifurcated for a distance from said one end of the tube, with said bifurcation terminating in a rounded end of said bifurcation at said distance from said one end, and one of said side walls is adapted to contact a side wall of an adjacent tube in the core;
said adapted side wall being joined in a fluid tight manner to said contacted side wall of said adjacent tube;
said collecting tank having walls thereof extending over said front and rear faces of said core past said bifurcation of said end walls and joined in a fluid tight manner to said end walls of said tubes along and beyond said bifurcation to thereby form a fluid tight joint between said walls of said collecting tank and said end walls of said tubes.

2. The radiator of claim 1 wherein both side walls are adapted to contact an adjacent tube.

3. The radiator of claim 1 wherein said bifurcation is formed by a slot opening at said one end of said tube and having sides spaced by a slot width joined at said distance from one end by a smooth curve forming said rounded end of said bifurcation.

4. The radiator of claim 1 wherein said end walls include a slit of negligible width in said formed segment opening to the end of the tube to bifurcate said end wall in said formed segment, and said slit terminates at said distance from said end of the tube in a circular hole having a diameter larger than said negligible width of said slit.

5. The radiator of claim 1 wherein said side wall of said tube includes a longitudinal rib which is removed from a flattened portion of said adapted side wall by compressing said flattened portion in a constrained manner such that material in said rib flows out of said flattened portion and partially into said end walls of said tube, to thereby provide flat joining surfaces of said adapted side wall and said end walls to facilitate joining said adapted side wall in a fluid tight manner to said contacted side wall of said adjacent tube and joining said collecting tank having walls to said end walls and joined in a fluid tight manner.

6. The radiator of claim 1 wherein said adapted side wall being is attached to said contacted side wall by a compression bond in addition to being joined in said fluid tight manner to said contacted side wall of said adjacent tube.

7. The radiator of claim 1 wherein said end walls are bifurcated in an asymmetrical manner with respect to said side walls with a larger portion of said bifurcated end wall joined to a first one of said side walls, and a smaller portion of said bifurcated end wall joined to the second side wall of said tube, and only said second side wall being adapted and joined to said contacted side wall of said adjacent tube.

8. A radiator comprising:
a radiator core defining a front and a rear face thereof and including a plurality of generally rectangular shaped tubes interleaved with layers of fins for passage of air through said core; and
a collecting tank attached to said core in a fluid tight manner to provide fluid communication between said tubes and said collecting tank;
said tubes each having a first and a second side wall extending through said core and joined by end walls at said front and rear faces of said core;
said tubes each terminating at one end thereof in a formed segment wherein said end walls of each tube include a first bifurcation for a first distance from said one end of the tube, and a second bifurcation for a second distance from said one end of the tube, with a first portion of said end wall joined for said first distance only to said first side wall, a second portion of said end wall joined for said second distance only to said second side wall, and a central portion of said end wall not joined to either said first and second portions of said end wall for said first and second distances respectively;
said first and second side walls are adapted to contact a side wall of an adjacent tube in the core;
said adapted side wall being joined in a fluid tight manner to said contacted side wall of said adjacent tube;
said collecting tank having walls thereof extending over said front and rear faces of said core past said first and second bifurcations of said end walls and joined in a fluid tight manner to said end walls of said tubes along and beyond said first and second bifurcations to thereby form a fluid tight joint between said walls of said collecting tank and said end walls of said tubes.

9. The radiator of claim 8 wherein at least one of the first and second bifurcations terminate in a smooth curve.

10. The radiator of claim 8 the first and second distances are equal.

11. A method for fabricating a header-less radiator comprising:
fabricating a plurality of tubes, each having a generally rectangular cross section comprised of a pair of spaced side walls joined by a pair of end walls;
adapting one end of each of said tubes to provide a formed segment having said end walls bifurcated for a distance from said one end and at least one side wall in said formed segment adapted to contact and seal against a side wall of an adjacent one of said tubes when said tubes are joined together in an interleaved configuration with layers of fin to form a radiator core, said bifurcation terminating in a smooth curve at said distance from said one end of the tubes;
assembling a radiator core in a manner defining a front and a rear face thereof and including said plurality of generally rectangular shaped tubes interleaved with layers of fins for passage of air through said core; said side walls of said tubes extending through said core with said end walls at said front and rear faces of said core; and with said adapted side walls in said formed segments of said tubes contacting a side wall of an adjacent tube in the core;
joining each said adapted side wall in said formed segments in a fluid tight manner to said contacted side wall of said adjacent tube;
attaching a collecting tank having walls thereof extending over said front and rear faces of said core past said bifurcation of said end walls; and
joining said collecting tank in a fluid tight manner to said end walls of said tubes along and beyond said bifurcation to thereby form a fluid tight joint between said walls of said collecting tank and said end walls of said tubes.

12. The method of claim 11 wherein the step of adapting one end of each of said tubes is carried out after assembling said radiator core.

13. The method of claim 12 wherein the step of adapting includes forming at least one of said side walls in said formed segment at said one end of said tubes to contact a side wall of an adjacent tube in said core by inserting a forming tool into said one end of each of said plurality of tubes.
